(19) United States
(12) Patent Application Publication
(10) Pub. No.: US 2024/0260669 A1
(43) Pub. Date: Aug. 8, 2024

(54) An Aerosol Generating Device and an Aerosol Generating System

(71) Applicant: JT International SA, Geneva (CH)

(72) Inventor: Eduardo Jose Garcia Garcia, Grand-Saconnex (CH)

(73) Assignee: JT International SA, Geneva (CH)

(21) Appl. No.: 18/274,128

(22) PCT Filed: Jan. 26, 2022
(86) PCT No.: PCT/EP2022/051733

§ 371 Date: Jul. 25, 2023

(30) Foreign Application Priority Data
Feb. 2, 2021 (EP) 21154682.5

(51) Int. Cl. A24F 40/465; A24F 40/20; A24F 40/70; H05B 6/10

(52) U.S. Cl. CPC A24F 40/465; A24F 40/20; A24F 40/70; H05B 6/105

(57) ABSTRACT

An aerosol generating device includes a heating chamber for receiving an aerosol generating substrate, the heating chamber including a chamber wall. A susceptor structure includes one or more inductively heatable susceptors disposed around the chamber wall and exposed to an interior volume of the heating chamber. Portions of the susceptor structure may extend from the chamber wall into the interior volume to support the aerosol generating substrate. Mounting portions of the susceptor structure are embedded in the chamber wall, for example by moulding the chamber wall around the mounting portions. The mounting portions may be provided by connector portions that connect different susceptors to each other mechanically and/or electrically.

### TECHNICAL FIELD

The present disclosure relates generally to an aerosol generating device, and more particularly to an aerosol generating device for heating an aerosol generating substrate to generate an aerosol for inhalation by a user. Embodiments of the present disclosure also relate to an aerosol generating system comprising an aerosol generating device and an aerosol generating substrate. The present disclosure is particularly applicable to a portable (hand-held) aerosol generating device. Such devices heat, rather than burn, an aerosol generating substrate, e.g., tobacco or other suitable materials, by conduction, convention, and/or radiation to generate an aerosol for inhalation by a user.

### TECHNICAL BACKGROUND

The popularity and use of reduced-risk or modified-risk devices (also known as aerosol generating devices or vapour generating devices) has grown rapidly in recent years as an alternative to the use of traditional tobacco products. Various devices and systems are available that heat or warm aerosol generating substances to generate an aerosol for inhalation by a user.

A commonly available reduced-risk or modified-risk device is the heated substrate aerosol generating device, or so-called heat-not-burn device. Devices of this type generate an aerosol or vapour by heating an aerosol generating substrate to a temperature typically in the range 150° C. to 300° C. Heating the aerosol generating substrate to a temperature within this range, without burning or combusting the aerosol generating substrate, generates a vapour which typically cools and condenses to form an aerosol for inhalation by a user of the device. In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

Currently available aerosol generating devices can use a number of different approaches to provide heat to the aerosol generating substrate. One such approach is to provide an aerosol generating device which employs an induction heating system. In such a device, an induction coil is provided in the device and an inductively heatable susceptor is provided to heat the aerosol generating substrate. When a user activates the device, electrical energy is supplied to the induction coil, which generates an alternating electromagnetic field. The susceptor couples with the electromagnetic field to induce local eddy currents and/or larger scale circulating currents to flow in the susceptor. The flow of currents in the susceptor generates resistive heating. Depending on the material of the susceptor, it may also undergo heating by magnetic hysteresis. Heat is transferred from the susceptor to the aerosol generating substrate, for example by thermal conduction, and an aerosol is generated as the aerosol generating substrate is heated.

It is generally desirable to heat an aerosol generating substrate rapidly, in order to attain and maintain a sufficiently high temperature in the aerosol generating substrate to generate a vapour. The present disclosure seeks to provide an aerosol generating device that rapidly heats an aerosol generating substrate to a desired temperature, while at the same time maximising the energy efficiency of the device.

### SUMMARY OF THE DISCLOSURE

According to a first aspect of the present disclosure, there is provided an aerosol generating device comprising:
a heating chamber for receiving at least part of an aerosol generating substrate, the heating chamber comprising a chamber wall that defines an interior volume of the heating chamber; and
a susceptor structure comprising a plurality of inductively heatable susceptors spaced around the chamber wall and exposed to the interior volume of the heating chamber;
wherein the susceptor structure further comprises mounting portions embedded in the chamber wall.

The aerosol generating device/system is configured to heat an aerosol generating substrate, without burning the aerosol generating substrate, to volatise at least one component of the aerosol generating substrate and thereby generate a heated vapour which cools and condenses to form an aerosol for inhalation by a user of the aerosol generating device/system. The aerosol generating device is typically a hand-held, portable, device. The aerosol generating device/system provides for rapid and controlled heating of the aerosol generating substrate, whilst at the same time maximising energy efficiency.

Embedding portions of the susceptor structure in the chamber wall ensures that the susceptor structure is securely mounted in relation to the heating chamber. The embedded portions are surrounded (though not necessarily completely surrounded) by the material of the chamber wall such that friction or, preferably, mechanical interference between the embedded portions and the wall material prevents the susceptor structure being removed from the wall, at least in a direction generally perpendicular to the surface of the wall.

The susceptors are located at positions around the periphery of the chamber where they can transmit heat, e.g. by thermal conduction, to an aerosol generating substrate received in the chamber. The susceptors may contact the aerosol generating substrate at the positions around the periphery of the chamber and thereby support the aerosol generating substrate in the chamber. The spaces between the susceptors around the periphery of the chamber may provide air channels between the aerosol generating substrate and the chamber wall. The plurality of susceptors are preferably regularly spaced around the chamber wall.

Preferably, the susceptor structure further comprises inwardly extending portions that extend from the chamber wall into the interior volume. The inwardly extending portions of the susceptor structure are able to contact the aerosol generating substrate to conduct heat to it and/or to support it in the heating chamber, while other portions of the susceptor structure are not in contact with the substrate.

The inwardly extending portions of the susceptor structure may stand clear of the chamber wall, thereby leaving a radial gap between each susceptor and the chamber wall, which provides further air channels through which air can be drawn through the chamber into the aerosol generating substrate.

The susceptor structure may be a plurality of discrete components, each component comprising one or more of the susceptors. Alternatively, the susceptor structure may be a single component. For example, the susceptor structure may be conveniently formed from a single sheet of material, e.g. by stamping the material to form a precursor structure, then folding the precursor structure to form the susceptor structure.

The susceptor structure may comprise connecting portions that connect two or more of the plurality of susceptors. Preferably, the connecting portions of the susceptor structure connect all of the plurality of susceptors. The connecting portions may serve a solely mechanical function to join the susceptors into a common physical structure. In some examples of aerosol generating device according to the present disclosure, the connecting portions may serve as electrical conductors to enable induced electric current to flow between the susceptors. In particular examples, the connecting portions may connect all of the plurality of susceptors of the susceptor structure in a continuous circuit around the heating chamber.

The connecting portions of the susceptor structure may be at least partly embedded in the chamber wall. This is a convenient way to arrange for portions of the susceptor structure to be embedded in the chamber wall, while the susceptors themselves are not embedded and remain exposed to the interior volume of the heating chamber.

Additionally or alternatively, each susceptor may comprise a mounting portion embedded in the chamber wall.

According to another aspect of the present disclosure, there is provided an aerosol generating system, comprising an aerosol generating device as previously described in combination with an aerosol generating substrate, at least part of the aerosol generating substrate being received in the heating chamber of the aerosol generating device.

According to a further aspect of the present disclosure, a method of manufacturing an aerosol generating device comprises:
forming a susceptor structure comprising a plurality of inductively heatable susceptors; and
moulding a chamber wall around the susceptor structure such that:
the chamber wall defines an interior volume of a heating chamber for receiving at least part of an aerosol generating substrate;
the inductively heatable susceptors are spaced around the chamber wall and exposed to the interior volume of the heating chamber; and
the susceptor structure comprises mounting portions embedded in the chamber wall.

Preferably, the susceptor structure further comprises inwardly extending portions that extend from the chamber wall into the interior volume.

Moulding the chamber wall around a pre-existing susceptor structure is a simple way of securely mounting the susceptor structure in relation to the heating chamber. It avoids the need to form special structures on the chamber wall for fixing the susceptor structure to the wall and it avoids the need for a separate manufacturing operation to fix the susceptor structure to the wall. The step of moulding the chamber wall may comprise injection moulding or any other moulding technique that is suitable for the material and desired structure of the chamber wall.

The chamber wall preferably comprises a material that is substantially not electrically conductive or magnetically permeable, in order that the chamber wall should not itself undergo inductive heating.

The chamber wall may comprise a heat-resistant plastics material. The chamber wall should not degrade when repeatedly exposed to the temperatures and other physical conditions at which the aerosol generating device will operate. A preferred plastics material is polyether ether ketone (PEEK), which is resistant to degradation by heat and also has the property of low thermal conductivity, thereby reducing the conduction of heat from the interior of the heating chamber to the exterior of the chamber wall. PEEK is substantially not electrically conductive or magnetically permeable.

The chamber wall may alternatively comprise a ceramic material such as alumina or zirconia. Ceramics are typically very resistant to degradation by heat and many of them also have low thermal conductivity, while being substantially not electrically conductive or magnetically permeable.

The susceptor structure preferably comprises a material that is electrically conductive and magnetically permeable, preferably a metallic material. If at least the susceptors of the susceptor structure are formed of such a material, they will be capable of undergoing inductive heating. The metallic material is typically selected from the group consisting of stainless steel and carbon steel. The inductively heatable susceptor could, however, comprise any suitable material including one or more, but not limited, of aluminium, iron, nickel, stainless steel, carbon steel, and alloys thereof, e.g. nickel chromium or nickel copper.

The aerosol generating device may include a power source and controller, e.g., comprising control circuitry, which may be configured to operate at a high frequency. The power source and circuitry may be configured to operate at a frequency of between approximately 80 kHz and 1 MHz, possibly between approximately 150 kHz and 250 kHz, and possibly at approximately 200 kHz. The power source and circuitry could be configured to operate at a higher frequency, for example in the MHz range, depending on the type of inductively heatable susceptor that is used.

The aerosol generating substrate may comprise any type of solid or semi-solid material. Example types of aerosol generating solids include powder, granules, pellets, shreds, strands, particles, gel, strips, loose leaves, cut filler, porous material, foam material or sheets. The aerosol generating substrate may comprise plant derived material and in particular, may comprise tobacco. It may advantageously comprise reconstituted tobacco, for example including tobacco and any one or more of cellulose fibres, tobacco stalk fibres and inorganic fillers such as CaCO₃.

Consequently, the aerosol generating device may be referred to as a “heated tobacco device”, a “heat-not-burn tobacco device”, a “device for vaporising tobacco products”, and the like, with this being interpreted as a device suitable for achieving these effects. The features disclosed herein are equally applicable to devices which are designed to vaporise any aerosol generating substrate.

The aerosol generating substrate may form part of an aerosol generating article and may be circumscribed by a paper wrapper. When the aerosol generating substrate is received in the heating chamber of the aerosol generating device, other parts of the aerosol generating article may remain outside the heating chamber to provide, for example, a mouthpiece for the user.

The aerosol generating article may be formed substantially in the shape of a stick, and may broadly resemble a cigarette, having a tubular region with an aerosol generating substrate arranged in a suitable manner. The aerosol generating article may include a filter segment, for example comprising cellulose acetate fibres, at a proximal end of the aerosol generating article. The filter segment may constitute a mouthpiece filter and may be in coaxial alignment with the aerosol generating substrate. One or more vapour collection regions, cooling regions, and other structures may also be included in some designs. For example, the aerosol generating article may include at least one tubular segment upstream of the filter segment. The tubular segment may act as a vapour cooling region. The vapour cooling region may advantageously allow the heated vapour generated by heating the aerosol generating substrate to cool and condense to form an aerosol with suitable characteristics for inhalation by a user, for example through the filter segment.

The aerosol generating substrate may comprise an aerosol former. Examples of aerosol formers include polyhydric alcohols and mixtures thereof such as glycerine or propylene glycol. Typically, the aerosol generating substrate may comprise an aerosol former content of between approximately 5% and approximately 50% on a dry weight basis. In some embodiments, the aerosol generating substrate may comprise an aerosol former content of between approximately 10% and approximately 20% on a dry weight basis, and possibly approximately 15% on a dry weight basis.

Upon heating, the aerosol generating substrate may release volatile compounds. The volatile compounds may include nicotine or flavour compounds such as tobacco flavouring.

### BRIEF DESCRIPTION OF THE DRAWINGS

FIG. 1 is a diagrammatic cross-sectional view of an aerosol generating system comprising an aerosol generating device and an aerosol generating article ready to be positioned in a heating chamber of the aerosol generating device;

FIG. 2 is a diagrammatic cross-sectional view of the aerosol generating system of FIG. 1, showing the aerosol generating article positioned in the heating chamber of the aerosol generating device;

FIG. 3 is a detailed diagrammatic perspective view of the heating chamber of the aerosol generating device of FIGS. 1 and 2, showing one of a plurality of inductively heatable susceptors mounted on an inner surface of the heating chamber and a coil support structure;

FIG. 4 is a diagrammatic cross-sectional view from an end of the heating chamber shown in FIG. 3, showing a susceptor structure comprising a plurality of discrete, inductively heatable susceptors spaced around a periphery of the heating chamber;

FIG. 5 is a diagrammatic view showing the detail of the susceptor structure of FIGS. 3 and 4;

FIG. 6 is a diagrammatic view similar to FIG. 5, showing a susceptor structure with an alternative geometry;

FIG. 7 is a diagrammatic cross-sectional view similar to FIG. 4, showing the susceptor structure of FIG. 6 mounted in the heating chamber;

FIG. 8 is a diagrammatic view similar to FIG. 5, showing a susceptor structure with another alternative geometry;

FIG. 9 is a diagrammatic cross-sectional view similar to FIG. 4, showing the susceptor structure of FIG. 8 mounted in the heating chamber;

FIG. 10 is a partial perspective view of a heating chamber, showing another way of securing susceptors to the chamber wall; and

FIG. 11 is a partial perspective view of a heating chamber, showing still another way of securing susceptors to the chamber wall.

### DETAILED DESCRIPTION OF EMBODIMENTS

Embodiments of the present disclosure will now be described by way of example only and with reference to the accompanying drawings.

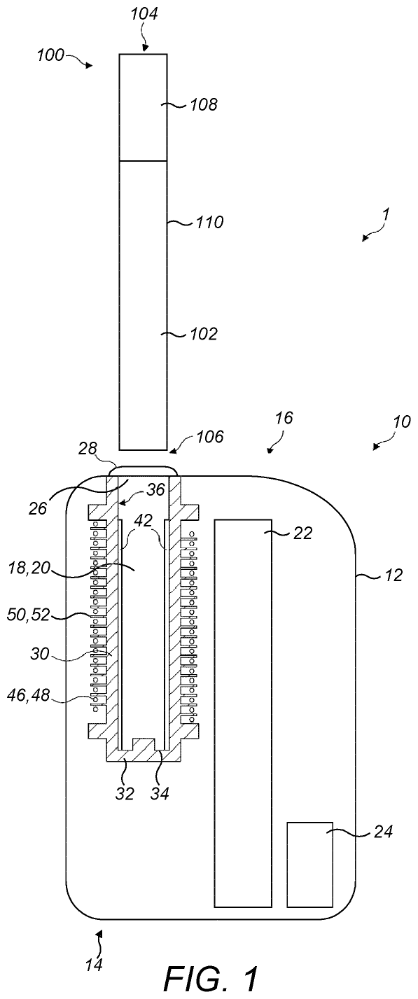

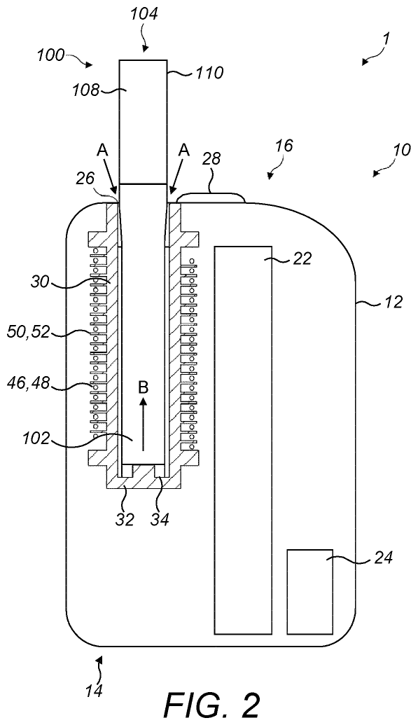

Referring initially to FIGS. 1 and 2, there is shown diagrammatically an example of an aerosol generating system 1. The aerosol generating system 1 comprises an aerosol generating device 10 and an aerosol generating article 100 for use with the device 10. The aerosol generating device 10 comprises a main body 12 housing various components of the aerosol generating device 10. The main body 12 can have any shape that is sized to fit the components described in the various embodiments set out herein and to be comfortably held by a user unaided, in a single hand.

A first end 14 of the aerosol generating device 10, shown towards the bottom of FIGS. 1 and 2, is described for convenience as a distal, bottom, base or lower end of the aerosol generating device 10. A second end 16 of the aerosol generating device 10, shown towards the top of FIGS. 1 and 2, is described as a proximal, top or upper end of the aerosol generating device 10. During use, the user typically orients the aerosol generating device 10 with the first end 14 downward and/or in a distal position with respect to the user's mouth and the second end 16 upward and/or in a proximal position with respect to the user's mouth.

The aerosol generating device 10 comprises a heating chamber 18 positioned in the main body 12. The heating chamber 18 defines an interior volume in the form of a cavity 20 having a substantially circular cross-section for receiving at least part of a substantially cylindrical aerosol generating article 100. The heating chamber 18 has a longitudinal axis defining a longitudinal direction. A proximal end 26 of the heating chamber 18 is open towards the second end 16 of the aerosol generating device 10. The heating chamber 18 is typically held spaced apart from the inner surface of the main body 12 to minimise heat transfer to the main body 12.

The aerosol generating device 10 further comprises a power source 22, for example one or more batteries which may be rechargeable, and a controller 24.

The aerosol generating device 10 can optionally include a sliding cover 28 movable transversely between a closed position (see FIG. 1) in which it covers the open end 26 of the heating chamber 18 to prevent access to the heating chamber 18 and an open position (see FIG. 2) in which it exposes the open first end 26 of the heating chamber 18 to provide access to the heating chamber 18. The sliding cover 28 can be biased to the closed position in some embodiments.

The heating chamber 18, and specifically the cavity 20, is arranged to receive a correspondingly shaped generally cylindrical or rod-shaped aerosol generating article 100. The aerosol generating article 100 typically comprises a pre-packaged aerosol generating substrate 102. The aerosol generating article 100 is a disposable and replaceable article (also known as a “consumable”) which may, for example, contain tobacco as the aerosol generating substrate 102. The aerosol generating article 100 has a proximal end 104 (or mouth end) and a distal end 106. The aerosol generating article 100 further comprises a mouthpiece segment 108 positioned downstream of the aerosol generating substrate 102. The aerosol generating substrate 102 and the mouthpiece segment 108 are arranged in coaxial alignment inside a wrapper 110 (e.g., a paper wrapper) to hold the components in position to form the rod-shaped aerosol generating article 100.

The mouthpiece segment 108 can comprise one or more of the following components (not shown in detail) arranged sequentially and in co-axial alignment in a downstream direction, in other words from the distal end 106 towards the proximal (mouth) end 104 of the aerosol generating article 100: a cooling segment, a centre hole segment and a filter segment. The cooling segment typically comprises a hollow paper tube having a thickness which is greater than the thickness of the wrapper 110. The centre hole segment may comprise a cured mixture containing cellulose acetate fibres and a plasticizer, and functions to increase the strength of the mouthpiece segment 108. The filter segment typically comprises cellulose acetate fibres and acts as a mouthpiece filter. As heated vapour flows from the aerosol generating substrate 102 towards the proximal (mouth) end 104 of the aerosol generating article 100, the vapour cools and condenses as it passes through the cooling segment and the centre hole segment to form an aerosol with suitable characteristics for inhalation by a user through the filter segment.

The heating chamber 18 has a side wall (or chamber wall) 30 extending between a base 32, located at a distal end 34 of the heating chamber 18, and the open end 26. The chamber wall 30 and the base 32 are connected to each another and can be integrally formed as a single piece. In the illustrated embodiment, the chamber wall 30 is tubular and, more specifically, cylindrical. In other embodiments, the chamber wall 30 can have other suitable shapes, such as a tube with an elliptical or polygonal cross section. In yet further embodiments, the chamber wall 30 can be tapered. The chamber wall 30 and the base 32 are formed of a heat-resistant plastics material, such as polyether ether ketone (PEEK).

In the illustrated embodiment, the base 32 of the heating chamber 18 is closed, e.g. sealed or air-tight. That is, the heating chamber 18 is cup-shaped. This can ensure that air drawn from the open end 26 is prevented by the base 32 from flowing out of the second end 34 and is instead guided through the aerosol generating substrate 102. It can also ensure that a user inserts the aerosol generating article 100 into the heating chamber 18 an intended distance and no further.

The aerosol generating device 10 comprises a susceptor structure 40, which in turn comprises a plurality of inductively heatable susceptors 42 circumferentially spaced around a periphery 44 of the heating chamber 18.

The inductively heatable susceptors 42 are elongate in the longitudinal direction of the heating chamber 18. Each inductively heatable susceptor 42 has a length and a width, and typically the length is at least five times the width. Each inductively heatable susceptor 42 has an inwardly extending portion 42a that extends into the heating chamber 18 in a radial direction from the side wall 30. The inwardly extending portion 42a can comprise an elongate rib or can comprise an inwardly deflected portion as shown in the drawings. The inwardly extending portions 42a extend towards and contact the aerosol generating substrate 102 as shown in FIG. 4. The inwardly extending portions 42a extend radially inwardly into the heating chamber 18 by a sufficient extent to reduce the effective cross-sectional area of the heating chamber 18. The inwardly extending portions 42a thus form a friction fit with the aerosol generating substrate 102, and more particularly with the wrapper 110 of the aerosol generating article 100, and may cause compression of the aerosol generating substrate 102 as best seen in FIG. 2. The compression of the aerosol generating substrate 102 improves thermal conduction between the susceptors 42 and the aerosol generating substrate 102. It will be understood by one of ordinary skill in the art that the inwardly extending portions 42a are not limited to the geometries shown in the drawings and that other geometries are entirely within the scope of the present disclosure. The inwardly extending portions 42a need not even be convex, provided they extend inwardly to a distance from the axis of the heating chamber 18 that is smaller than the distance of the chamber wall 30, such that the aerosol generating substrate 102 contacts the inwardly extending portions 42a rather than the chamber wall 30.

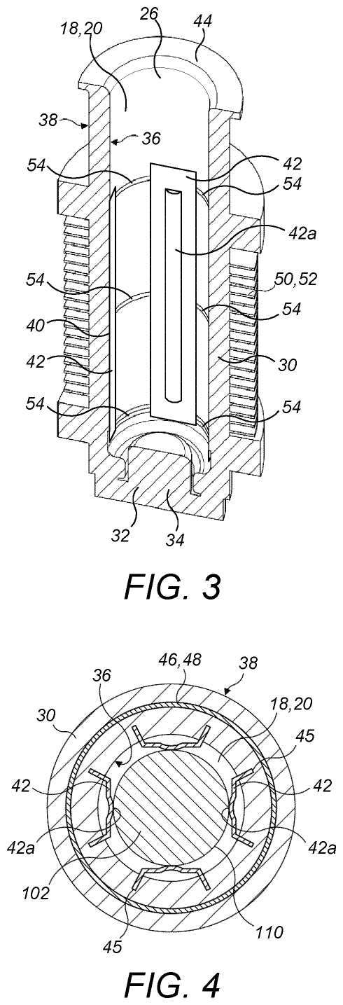

FIGS. 3 to 5 illustrate a susceptor structure 40 that consists of a plurality of discrete susceptors 42, which are circumferentially spaced around the periphery 44 of the heating chamber 18 and are not mechanically or electrically connected to each other. Each susceptor 42 is mounted in the heating chamber 18 by mounting portions 45, which take the form of wing-like extensions of the susceptor 42. The mounting portions 45 are embedded in the chamber wall 30 such that the susceptors 42 are mechanically fixed and cannot be withdrawn from the heating chamber 18.

The mounting portions 45 are embedded in the chamber wall 30 when the heating chamber 18 is formed. In one method of manufacture, the susceptor structure 40 is placed in a mould (not illustrated). If the susceptor structure 40 consists of a plurality of discrete susceptors 42, as illustrated in FIGS. 3 to 5, the susceptors 42 may need to be temporarily supported in the desired configuration in the mould. The chamber material is then introduced into the mould in liquid form, for example by injection moulding, to fill the space around the mounting portions 45. The material is then cooled, cured or otherwise treated in a conventional manner to form a solid chamber wall 30, in which the mounting portions are embedded.

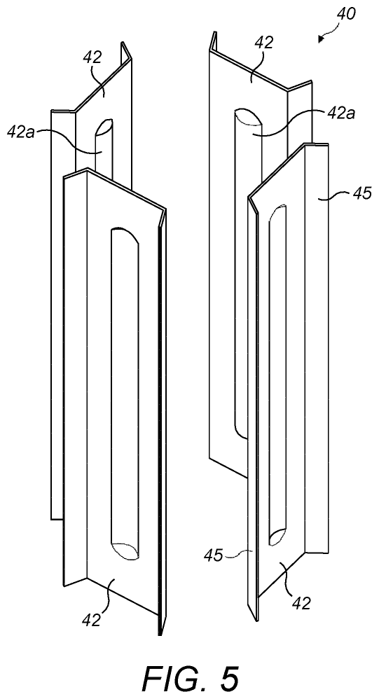

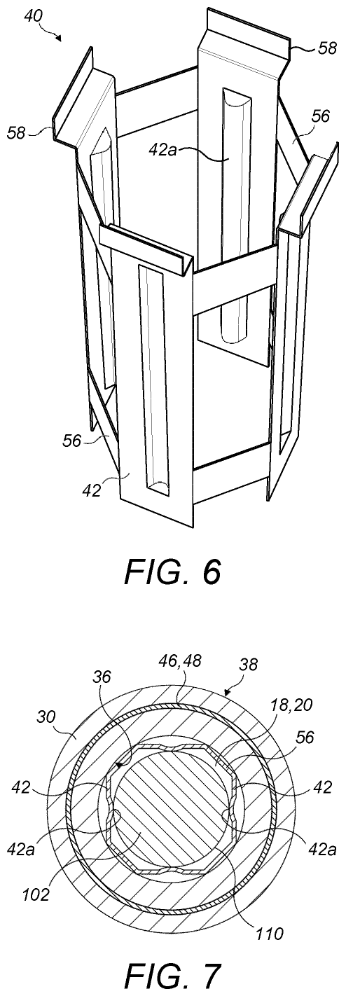

It will be understood by one of ordinary skill in the art that the mounting portions 45 are not limited to the geometries shown in the drawings and that other geometries are entirely within the scope of the present disclosure. For example, the wing-like mounting portions 45 shown in FIG. 5 need not extend the full length of the susceptors 42. Alternatively, the mounting portions 45 could be formed at one or both end of each susceptor 42 as seen in FIG. 6. The mounting portions 45 need not be at the periphery of the susceptors 42; they could be formed, e.g. by moulding or by cutting and folding, at the rear of a central part of each susceptor 42.

The aerosol generating device 10 comprises an electromagnetic field generator 46 for generating an electromagnetic field. The electromagnetic field generator 46 comprises a substantially helical induction coil 48. The induction coil 48 has a circular cross-section and extends helically around the substantially cylindrical heating chamber 18. The induction coil 48 can be energised by the power source 22 and controller 24. The controller 24 includes, amongst other electronic components, an inverter which is arranged to convert a direct current from the power source 22 into an alternating high-frequency current for the induction coil 48.

The chamber wall 30 of the heating chamber 18 includes a coil support structure 50 formed in the outer surface 38. In the illustrated example, the coil support structure 50 comprises a coil support groove 52, which extends helically around the outer surface 38. The induction coil 48 is positioned in the coil support groove 52 and is, thus, securely and optimally positioned with respect to the inductively heatable susceptors 42.

In order to use the aerosol generating device 10, a user displaces the sliding cover 28 (if present) from the closed position shown in FIG. 1 to the open position shown in FIG. 2. The user then inserts an aerosol generating article 100 through the open end 26 of the heating chamber 18, so that the aerosol generating substrate 102 is received in the cavity 20 and at least part of the mouthpiece segment 108 projects from the open end 26 to permit engagement by a user's lips.

Upon activation of the aerosol generating device 10 by a user, the induction coil 48 is energised by the power source 22 and controller 24 which supply an alternating electrical current to the induction coil 48, and an alternating and time-varying electromagnetic field is thereby produced by the induction coil 48. This couples with the inductively heatable susceptors 42 and generates eddy currents and/or magnetic hysteresis losses in the susceptors 42 causing them to heat up. Heat is then transferred from the inductively heatable susceptors 42 to the aerosol generating substrate 102, for example by conduction, radiation and convection. This results in heating of the aerosol generating substrate 102 without combustion or burning, and a vapour is thereby generated. The generated vapour cools and condenses to form an aerosol which can be inhaled by a user of the aerosol generating device 10 through the mouthpiece segment 108, and more particularly through the filter segment.

The vaporisation of the aerosol generating substrate 102 is facilitated by the addition of air from the surrounding environment, for example through the open end 26 of the heating chamber 18, the air being heated as it flows between the wrapper 110 of the aerosol generating article 100 and the inner surface 36 of the chamber wall 30. More particularly, when a user sucks on the filter segment, air is drawn into the heating chamber 18 through the open end 26 as illustrated by the arrows A in FIG. 2. The air entering the heating chamber 18 flows from the open end 26 towards the closed end 34, between the wrapper 110 and the inner surface 36 of the chamber wall 30. As noted above, the susceptors 42 extend into the heating chamber 18 by a sufficient distance to at least contact the outer surface of the aerosol generating article 100, and typically to cause at least some degree of compression of the aerosol generating article 100. Consequently, there is no air gap all the way around the heating chamber 18 in the circumferential direction. Instead, there are air flow paths in the circumferential regions (four equally spaced gap regions) between the susceptors 42, along which air flows from the open end 26 towards the closed end 34 of the heating chamber 18. When the air reaches the closed end 34 of the heating chamber 18, it turns through approximately 1800 and enters the distal end 106 of the aerosol generating article 100. The air is then drawn through the aerosol generating article 100, as illustrated by the arrow B in FIG. 2, from the distal end 106 towards the proximal (mouth) end 104 along with the generated vapour.

In some examples of aerosol generating device, there may be more or fewer than four susceptors 42 and, thus, a corresponding number of air flow paths formed by the spaces between them. The susceptors 42 are preferably spaced at equal intervals around the chamber wall 30. As illustrated in FIGS. 4, 7 and 9, at least the inwardly extending portions 42a of the susceptors 42 may be formed to stand clear of the chamber wall 30, thereby leaving a radial gap for airflow between the susceptors 42 and the chamber wall 30. By allowing the incoming air to flow over one or both surfaces of the susceptors 42, the air may advantageously be pre-heated before it enters the aerosol generating substrate 102.

A user can continue to inhale aerosol all the time that the aerosol generating substrate 102 is able to continue to produce a vapour, e.g. all the time that the aerosol generating substrate 102 has vaporisable components left to vaporise into a suitable vapour. The controller 24 can adjust the magnitude of the alternating electrical current passed through the induction coil 48 to ensure that the temperature of the inductively heatable susceptors 42, and in turn the temperature of the aerosol generating substrate 102, does not exceed a threshold level. Specifically, at a particular temperature, which depends on the constitution of the aerosol generating substrate 102, the aerosol generating substrate 102 will begin to burn. This is not a desirable effect and temperatures above and at this temperature are avoided. The material from which the chamber wall 30 and the base 32 are formed is chosen to be able to resist being heated repeatedly to temperatures up to the threshold during the expected lifetime of the aerosol generating device.

To assist with temperature regulation, in some examples the aerosol generating device 10 is provided with a temperature sensor (not shown). The controller 24 is arranged to receive an indication of the temperature of the aerosol generating substrate 102 from the temperature sensor and to use the temperature indication to control the magnitude of the alternating electrical current supplied to the induction coil 48. In one example, the controller 24 may supply a first magnitude of electrical current to the induction coil 48 for a first time period to heat the inductively heatable susceptors 42 to a first temperature. Subsequently, the controller 24 may supply a second magnitude of alternating electrical current to the induction coil 48 for a second time period to heat the inductively heatable susceptors 42 to a second temperature. The second temperature may be lower than the first temperature. Subsequently, the controller 24 may supply a third magnitude of alternating electrical current to the induction coil 48 for a third time period to heat the inductively heatable susceptors 42 to the first temperature again. This may continue until the aerosol generating substrate 102 is expended (i.e. all vapour which can be generated by heating has already been generated) or the user stops using the aerosol generating device 10. In another scenario, once the first temperature has been reached, the controller 24 can reduce the magnitude of the alternating electrical current supplied to the induction coil 48 to maintain the aerosol generating substrate 102 at the first temperature throughout a session.

A single inhalation by a user is generally referred to a “puff”. In some scenarios, it is desirable to emulate a cigarette smoking experience, which means that the aerosol generating device 10 is typically capable of holding sufficient aerosol generating substrate 102 to provide ten to fifteen puffs.

In some embodiments, the controller 24 is configured to count puffs and to interrupt the supply electrical current to the induction coil 48 after ten to fifteen puffs have been taken by a user. Puff counting can be performed in a variety of different ways. In some embodiments, the controller 24 determines when a temperature decreases during a puff, as fresh, cool air flows past the temperature sensor (not shown), causing cooling which is detected by the temperature sensor. In other embodiments, air flow is detected directly using a flow detector. Other suitable methods will be apparent to one of ordinary skill in the art. In other embodiments, the controller 24 additionally or alternatively interrupts the supply of electrical current to the induction coil 48 after a predetermined amount of time has elapsed since a first puff. This can help to both reduce power consumption and provide a back-up for switching off the aerosol generating device 10 in the event that the puff counter fails to correctly register that a predetermined number of puffs has been taken.

In some examples, the controller 24 is configured to supply an alternating electrical current to the induction coil 48 so that it follows a predetermined heating cycle, which takes a predetermined amount of time to complete. Once the cycle is complete, the controller 24 interrupts the supply of electrical current to the induction coil 48. In some cases, this cycle may make use of a feedback loop between the controller 24 and a temperature sensor (not shown). For example, the heating cycle may be parameterised by a series of temperatures to which the inductively heatable susceptors 42 (or, more specifically, the temperature sensor) are heated or allowed to cool. The temperatures and durations of such a heating cycle can be empirically determined to optimise the temperature of the aerosol generating substrate 102. This may be necessary as direct measurement of the temperature of the aerosol generating substrate 102 can be impractical or misleading, for example where the outer layer of the substrate and the core are at different temperatures.

The power source 22 is sufficient to at least bring the aerosol generating substrate 102 in a single aerosol generating article 100 up to the first temperature and maintain it at the first temperature to provide sufficient vapour for at least ten to fifteen puffs. More generally, in line with emulating the experience of cigarette smoking, the power source 22 is usually sufficient to repeat this cycle (bring the aerosol generating substrate 102 up to the first temperature, maintain the first temperature and vapour generation for ten to fifteen puffs) ten times, or even twenty times, thereby emulating a user's experience of smoking a packet of cigarettes, before there is a need to replace or recharge the power source 22.

In general, the efficiency of the aerosol generating device 10 is improved when as much as possible of the heat that is generated by the inductively heatable susceptors 42 results in heating of the aerosol generating substrate 102. To this end, the aerosol generating device 10 is usually configured to provide heat in a controlled manner to the aerosol generating substrate 102 while reducing heat loss to other parts of the aerosol generating device 10. In particular, heat flow to parts of the aerosol generating device 10 that the user handles is kept to a minimum, thereby keeping these parts cool and comfortable to hold.

FIG. 6 illustrates an alternative form of susceptor structure 40, which is formed integrally as a single component. The susceptor structure 40 comprises four susceptors 42 arranged in a similar configuration to FIG. 5 but in this example the susceptors 42 are linked by connecting portions 56 that extend generally circumferentially around the structure 40 between adjacent pairs of susceptors 42. As shown, the connecting portions 56 form two complete rings around the susceptor structure 40 near its upper and lower ends. This gives good structural strength to the susceptor structure 40, which therefore does not need to be supported while the chamber wall 30 is moulded around it. For this purpose, the connecting portions 56 do not need to be electrically conductive. However, the connecting portions 56 are preferably made of an electrically conductive material, in which case they enable induced electrical currents to flow between different susceptors 42. In the illustrated geometry, the connecting portions 56 enable induced electrical currents to flow in a complete circuit between all the susceptors 42, as also seen in the cross section of FIG. 7. A third possibility is that the connecting portions may be, for example, conductive wires (not illustrated), which provide electrical connections between the susceptors 42 but do not provide mechanical support to the susceptor structure 40.

The susceptor structure 40 shown in FIGS. 6 and 7 also comprises mounting portions 58. In this example, the mounting portions 58 are provided at the upper ends of the susceptors 42. They serve the same purpose as the mounting portions 45 of FIG. 5, namely, to fix the susceptor structure 40 securely in the heating chamber 18. Again, the chamber wall 30 of the heating chamber 18 may be formed by moulding it around the mounting portions 58 to embed them in the finished solid wall and thereby prevent removal of the susceptor structure 40 from the heating chamber 18. Because the susceptor structure 40 is a single component, it may be made sufficiently rigid for the connecting portions 58 to hold the susceptors 42 in a defined relationship and there is no possibility of a single susceptor 42 being detached from the chamber wall 30. Therefore the mounting portions 58 are only required, in combination, to prevent removal of the whole susceptor structure 40 from the chamber 18 by sliding it upwards. As a result of this constraint on the freedom of movement of the susceptor structure 40, in this example it may not be necessary for the mounting portions 58 to be embedded in the chamber wall 18. For example, the chamber wall 18 could be configured to have a shoulder (not illustrated) at its upper end that engages the mounting portions 58 to prevent upward movement of the susceptor structure 40. The reader will readily be able to envisage an arrangement in which the susceptor structure 40 is held in the heating chamber 18 by additional or alternative mounting portions (not illustrated) formed at the lower ends of the susceptors 42.

The susceptor structure 40 shown in FIG. 6 may be formed from a single sheet of material by stamping a precursor structure from the sheet, then folding the precursor structure to form the susceptor structure 40. Because the material of the sheet is to form the susceptors 42, it should be electrically conductive and magnetically permeable, and is preferably a metallic material. In the precursor structure (not illustrated), the four susceptors 42 lie in a common plane but their inwardly extending portions 42a may be formed during the stamping process by deforming the sheet of material out of the plane. The mounting portions 45 may also be bent out of the plane during the stamping process or in a subsequent folding step. After the precursor structure has been formed, it is folded along lines parallel to the length of the susceptors 42 to form the ring-shaped structure seen in FIG. 6. The ends of the precursor structure may be joined by any suitable means, such as soldering, welding or mechanical engagement of co-operating parts, to create the desired mechanical and/or electrical connection around the susceptor structure 40.

It is not essential that the susceptor structure 40 should be stamped and folded from a sheet of material. Other suitable methods of manufacturing the desired structure, including casting and moulding, are also possible. The susceptors 42 and the connecting portions 56 may be formed from different materials in order to optimise their respective functions.

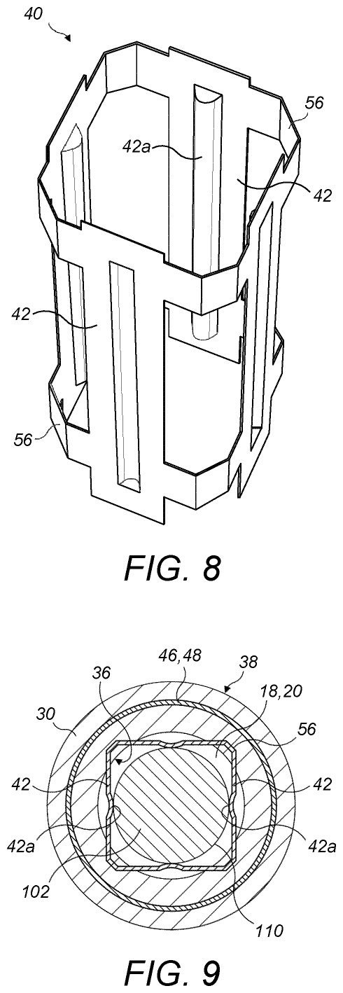

FIGS. 8 and 9 illustrate another variant of the susceptor structure 40, which is generally similar to the structure 40 of FIGS. 6 and 7 so will not be described in detail. FIG. 7 shows that as the connecting portions 56 of that example extend between adjacent susceptors 42, they lie within the cavity 20 of the heating chamber 18. In the example of FIGS. 8 and 9, the connecting portions 56 have a different geometry such that they extend to a distance from the axis of the susceptor structure 40 that is greater than the radius of the inner surface 36 of the chamber wall 30. The connecting portions 56 thereby become embedded in the chamber wall 30 when it is moulded around the susceptor structure 40. Accordingly, in this example the connecting portions 56 also serve as mounting portions to secure the susceptor structure 40 in the heating chamber 18. The mounting portions 58 at the ends of the susceptors 42 in FIG. 6 are unnecessary in the susceptor structure 40 of FIG. 8 and have been omitted.

It will be understood by one of ordinary skill in the art that the connecting portions 56 are not limited to the geometries shown in FIGS. 6 to 9 and that other geometries are entirely within the scope of the present disclosure. For example, the connecting portions 56 may be provided in only a single ring, and they do not need to be axially positioned near to the ends of the susceptor structure 40. In a further variant, successive connecting portions 56 around the ring could be axially offset from one another, e.g. alternately near to the upper and lower ends of the structure 40, to encourage the induced current to flow in a circuit that includes the axial lengths of the susceptors 42.

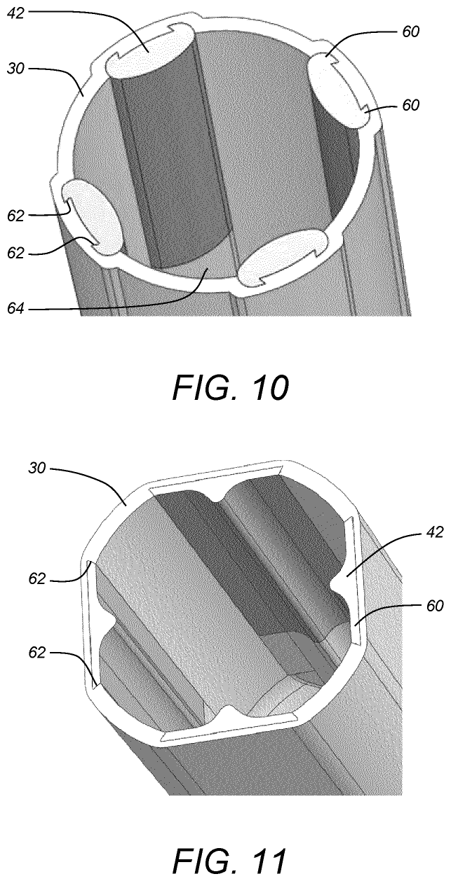

FIG. 10 illustrates a further variant of a heating chamber 18 for an aerosol generating device 10, having susceptors 42 embedded in the chamber wall 30. There are four discrete susceptors 42, which extend generally parallel to the axis of the chamber 18. Each susceptor 42 is secured to the wall 30 by a dovetail joint, whereby each susceptor 42 comprises a pair of mounting portions 60, each mounting portion 60 having an angled interface 62 with the material of the chamber wall 30, which prevents the susceptor 42 being moved away from the wall in a generally perpendicular direction. This arrangement may be achieved by moulding the material of the chamber wall 30 in situ around the mounting portions 60, as previously described. Alternatively, the same arrangement may be achieved by first forming the chamber wall 30 with channels 64 having a suitable profile, then sliding the susceptors 42 axially into the channels 64. By reversing this movement, the susceptors 42 could be removed axially from the heating chamber 18, e.g. for replacement or cleaning, while the mounting portions 60 prevent them being dismounted inadvertently from the chamber wall 30 during use of the device.

FIG. 11 illustrates another variant, which is similar to FIG. 10 except that the susceptors 42 have a different profile. Again, each susceptor 42 is secured to the wall 30 by a dovetail joint, whereby a pair of angled interfaces 62 between the mounting portion 60 of the susceptor and the material of the chamber wall 30 prevents the susceptor 42 being moved away from the wall in a generally perpendicular direction. Whereas in FIG. 10 the angled interfaces 62 of each pair converge in an outward direction, in FIG. 11 the angled interfaces 62 of each pair converge in a inward direction.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. An aerosol generating device comprising:
a heating chamber for receiving an aerosol generating substrate, the heating chamber comprising a chamber wall that defines an interior volume of the heating chamber; and
a susceptor structure comprising a plurality of inductively heatable susceptors spaced around the chamber wall and exposed to the interior volume of the heating chamber;
wherein the susceptor structure further comprises mounting portions embedded in the chamber wall.

2. The aerosol generating device according to claim 1, wherein the plurality of inductively heatable susceptors further comprises respective inwardly extending portions that extend from the chamber wall into the interior volume.

3. The aerosol generating device according to claim 2, wherein the inwardly extending portions of the plurality of inductively heatable susceptors stand clear of the chamber wall, thereby leaving a radial gap between each of the plurality of inductively heatable susceptors and the chamber wall.

4. The aerosol generating device according to claim 1, wherein the susceptor structure further comprises connecting portions that connect two or more of the plurality of inductively heatable susceptors.

5. The aerosol generating device according to claim 4, wherein the connecting portions of the susceptor structure connect all of the plurality of inductively heatable susceptors.

6. The aerosol generating device according to claim 5, wherein the connecting portions of the susceptor structure connect the plurality of inductively heatable susceptors in a continuous circuit around the heating chamber.

7. The aerosol generating device according to claim 4, 6, wherein the connecting portions provide the mounting portions of the susceptor structure embedded in the chamber wall.

8. The aerosol generating device according to claim 1, wherein each of the plurality of inductively heatable susceptors comprises one of the mounting portions embedded in the chamber wall.

9. A method of manufacturing an aerosol generating device comprising:
forming a susceptor structure comprising a plurality of inductively heatable susceptors; and
moulding a chamber wall around the susceptor structure such that:
the chamber wall defines an interior volume of a heating chamber for receiving an aerosol generating substrate;
the plurality of inductively heatable susceptors are spaced around the chamber wall and exposed to the interior volume of the heating chamber; and
the susceptor structure comprises mounting portions embedded in the chamber wall.

10. The method according to claim 9, wherein the plurality of inductively heatable susceptors further comprises respective inwardly extending portions that extend from the chamber wall into the interior volume.

11. The method according to claim 10, wherein the inwardly extending portions of the plurality of inductively heatable susceptors stand clear of the chamber wall, thereby leaving a radial gap between each of the plurality of inductively heatable susceptors and the chamber wall.

12. The method according to claim 9, wherein the step of moulding the chamber wall comprises injection moulding.

13. The method according to claim 9, wherein the chamber wall comprises a material that is substantially not electrically conductive or magnetically permeable.

14. The method according to claim 9, wherein the chamber wall comprises a heat-resistant plastics material.

15. The method according to claim 9, wherein the chamber wall comprises a ceramic material.

16. The method according to claim 9, wherein the step of forming the susceptor structure comprises stamping a precursor structure, then folding the precursor structure to form the susceptor structure.

17. The method according to claim 9, wherein the susceptor structure comprises a material that is electrically conductive and magnetically permeable.

18. The method according to claim 14, wherein the heat-resistant plastics material is polyether ether ketone.

19. The method according to claim 17, wherein the material is a metallic material.
